(19) United States
(12) Patent Application Publication
(10) Pub. No.: US 2001/0016878 A1
(43) Pub. Date: Aug. 23, 2001

(54) Communicating system and communicating method for controlling throughput

(76) Inventor: Hideki Yamanaka, Kawasaki (JP)

Correspondence Address: STAAS & HALSEY, Suite 500, 700 Eleventh Street, N.W., Washington, DC, 20001, US

(21) Appl. No.: 09/752,464

(22) Filed: Jan. 3, 2001

(30) Foreign Application Priority Data
Feb. 17, 2000 (JP) 2000-040009

(51) Int. Cl. G06F 15/16

(52) U.S. Cl. 709/234; 709/246

(57) ABSTRACT

An application protocol of a connection between a server and a client is converted into a multiplexing protocol having a huge communication window. The resultant connection is repeated. Since an agent relaying device receives data from the server using a large buffer, a throughput assigned by the server to the connection is increased.

### BACKGROUND OF THE INVENTION

1. Field of the Invention

The present invention relates to a communicating system and a communicating method for controlling a throughput in a communication between a client and a server, especially, in long distance Internet communications having large delays such as intercontinental communications and satellite communications.

2. Description of the Related Art

Since long distance Internet communications such as intercontinental communications and satellite communications have larger delays than short distance communications, a communication throughput between a client and a server decreases. The communication throughput represents the amount of data that is transferred in a predetermined time period. Conventionally, the communication bottleneck in a network having a large delay is solved by the following two methods.

(1) A network that has a physically large band-width is built.

(2) Mirror servers having the same contents as a main server are distributed in the vicinity of clients so that when a client accesses a main server, the main server redirects the access to an appropriate mirror server.

In the method (1), although the bandwidth for communications of many users can be increased, a delay depending on a physical distance (physical delay) cannot be decreased.

On the other hand, in the method (2), a broadband network having a low delay can be accomplished in a short distance between a main server and a client without a physical delay therebetween. However, since contents that can be mirrored are restricted, although a simple object (data) can be very effectively downloaded, the method (2) is not suitable for a communication for updating a database of a server using a CGI (Common Gateway Interface).

In addition, the cost of mirror servers is high. The cost reduction of intercontinental communications using optical fibers corresponding to the wave length multiplexing method is remarkable. Thus, it is becoming meaningless to dispose many expensive mirror servers so as to improve only the bandwidth.

### SUMMARY OF THE INVENTION

An object of the present invention is to provide a communication system and a communication method that allow a throughput between a client and a server to be improved at a lower cost than before.

A first aspect of the present invention is a communicating system comprising a buffer and a transferring device. The communicating system repeats a communication between a server and a client. The buffer buffers data transmitted from the server to the client and accelerates the data that is output from the server so as to increase a throughput assigned by the server to a connection to the client. The transferring device transfers the data stored in the buffer to the client.

A second aspect of the present invention is a communicating system comprising a receiving device, a converting device, and a transmitting device. The communicating system repeats a communication between a server and a client. The receiving device receives data that is transmitted from the server to the client. The converting device converts a protocol of the received data into another protocol that allows larger amount of data to be transmitted at a time. The transmitting device transmits the data converted by the converting device to the network.

A third aspect of the present invention is a communicating system comprising a receiving device, a converting device, and a transmitting device. The communicating system repeats a communication between a server and a client. The receiving device receives data of which a protocol of data transmitted from the server to the client is converted into another protocol that allows a larger amount of data to be transferred at a time from a network than the amount of data that is transmitted corresponding to the original protocol. The converting device converts the protocol of the received data into the original protocol. The transmitting device transmits data converted by the converting device to the client.

These and other objects, features and advantages of the present invention will become more apparent in light of the following detailed description of a best mode embodiment thereof, as illustrated in the accompanying drawings.

### BRIEF DESCRIPTION OF DRAWINGS

FIG. 1 is a block diagram showing the theory of a communicating system according to the present invention;

FIG. 2 is a schematic diagram showing the structure of a first communicating system;

FIG. 3 is a schematic diagram showing the structure of a second communicating system;

FIG. 4 is a schematic diagram showing a throttling control;

FIG. 5 is a schematic diagram showing a premium user service;

FIG. 6 is a schematic diagram showing a client mirroring service;

FIG. 7 is a block diagram showing the structure of a first agent relaying device;

FIG. 8 is a block diagram showing the structure of an authenticating and charging portion;

FIG. 9 is a first part of a flow chart of a process of the agent relaying device;

FIG. 10 is a second part of the flow chart of the process of the agent relaying device;

FIG. 11 is a flow chart showing an authenticating and charging process;

FIG. 12 is a schematic diagram showing the structure of an information processing device;

FIG. 13 is a schematic diagram showing a record medium; and

FIG. 14 is a block diagram showing the structure of a second agent relaying device.

### DESCRIPTION OF PREFERRED EMBODIMENT

Next, with reference to the accompanying drawings, an embodiment of the present invention will be described in details.

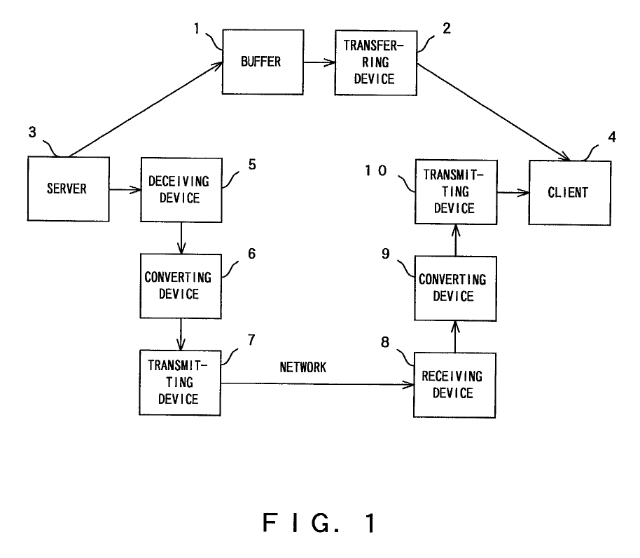

FIG. 1 is a block diagram showing the theory of the present invention.

A first aspect of the present invention is a communicating system comprising a buffer 1 and a transferring device 2. The communicating system relays a communication between a server 3 and a client 4.

The buffer 1 buffers data transmitted from the server 3 to the client 4 and accelerates the data that is output from the server 3 so as to increase a throughput assigned by the server 3 to a connection to the client 4. The transferring device 2 transfers the data stored in the buffer 1 to the client 4.

The buffer 1 has a storage capacity larger than a receiving buffer of the client 4 so as to receive data transmitted from the server 3 to the client 4 at high speed. Thus, the transmission rate of the data transmitted from the server 3 increases. The transferring device 2 transfers the data received by the buffer 1 at high speed to the client 4.

Since the server 3 normally assigns a large throughput to a connection having a small network delay, as the transmission rate of the server 3 increases, a throughput assigned to a connection between the server 3 and the client 4 increases. Thus, even if a delay that takes place between the server 3 and the client 4 is large, a high speed communication can be accomplished without need to dispose a mirror server.

A second aspect of the present invention is a communicating system comprising a receiving device 5, a converting device 6, and a transmitting device 7. The communicating system relays a communication between a server 3 and a client 4.

The receiving device 5 receives data that is transmitted from the server 3 to the client 4. The converting device 6 converts a protocol of the received data into another protocol that allows larger amount of data to be transmitted at a time. The transmitting device 7 transmits the data converted by the converting device 6 to the network.

The converting device 6 converts the protocol of the data received by the receiving device 5 into another protocol. The transmitting device 7 transmits a larger amount of data to the network at a time corresponding to the converted protocol than the amount of data that is transmitted corresponding to the original protocol. Thus, the amount of data that is transmitted to the client 4 at a time increases. As a result, a high speed communication can be accomplished without need to dispose a mirror server.

A third aspect of the present invention is a communicating system comprising a receiving device 8, a converting device 9, and a transmitting device 10. The communicating system relays a communication between a server 3 and a client 4.

The receiving device 8 receives data of which a protocol of data transmitted from the server 3 to the client 4 is converted into another protocol that allows a larger amount of data to be transferred at a time from a network than the amount of data that is transmitted corresponding to the original protocol. The converting device 9 converts the protocol of the received data into the original protocol. The transmitting device 10 transmits data converted by the converting device 9 to the client 4.

The receiving device 8 receives data transmitted by the transmitting device 7 from the network. The converting device 9 converts the protocol of the received data into the original protocol. The transmitting device 10 transmits the data to the client 4 corresponding to the original protocol. Thus, the amount of data that is transferred from the transmitting device 7 to the receiving device 8 at a time increases. As a result, a high speed communication can be accomplished without need to dispose a mirror server.

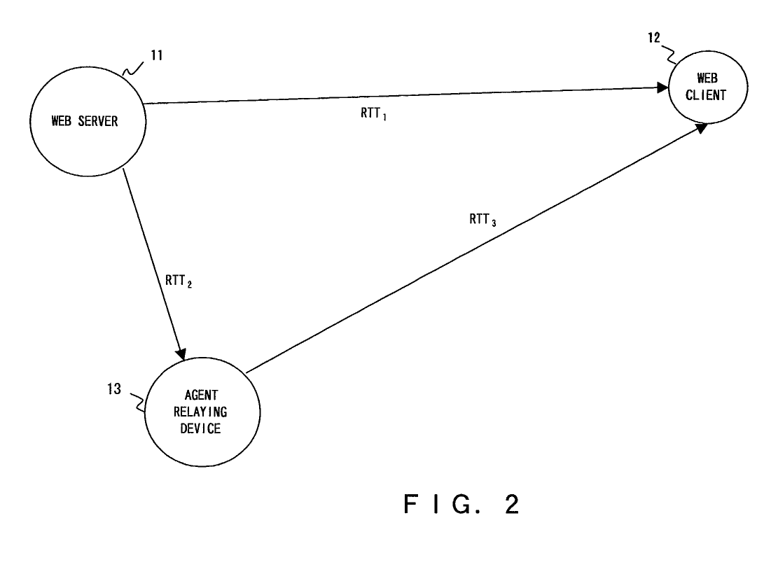

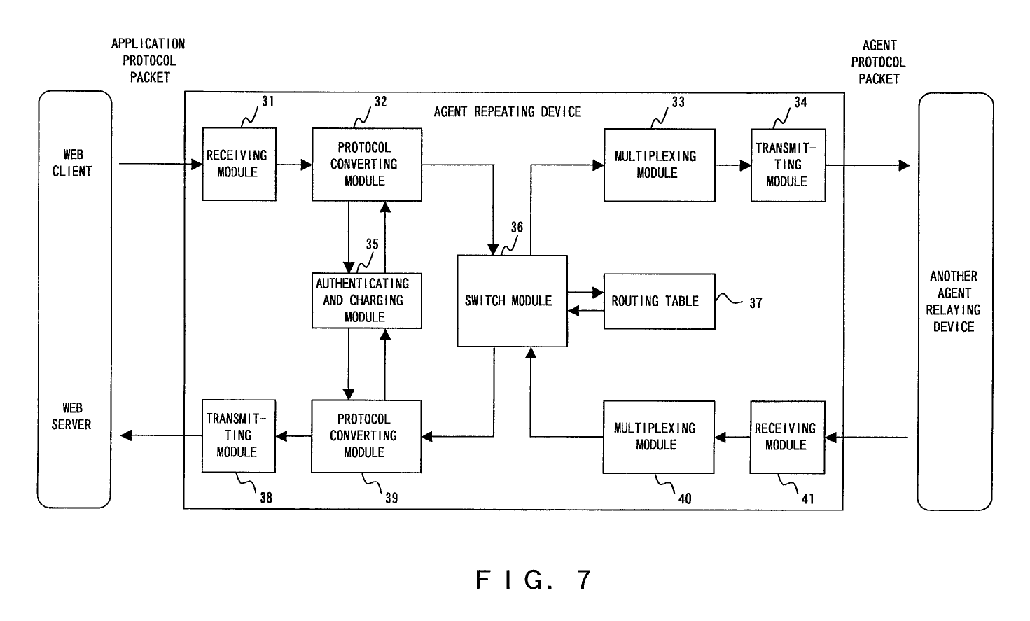

For example, the buffer 1 and the transferring device 2 shown in FIG. 1 correspond to an agent relaying device 13 shown in FIG. 2 (the agent relaying device 13 will be described later). The receiving device 5, the converting device 6, the transmitting device 7, the receiving device 8, the converting device 9, and the transmitting device 10 shown in FIG. 1 correspond to a receiving module 31, a protocol converting module 32, a transmitting module 34, a receiving module 41, a protocol converting module 39, and a transmitting module 38 shown in FIG. 7 (these modules will be described later), respectively.

In an intercontinental communication, if expensive mirror servers are not distributed, a throughput on the client side decreases because of a delay of the long distance communication. There are three major causes against the decrease of the throughput on the client side.

(1) The absolute delay that is physically determined

(2) A delay due to a communication protocol

(3) Scheduling that decreases a throughput assigned by a server to a connection having a large delay.

The delay (1) cannot be solved unless an ultra light speed communication is accomplished. The delay (2) can be much reduced in comparison with the delay (1) when a communication protocol and a communication system are properly improved. In the scheduling (3), a server assigns a small throughput to a connection having a large delay viewed from the server. When the delay of a connection to the client estimated from the server is decreased, the throughput can be improved.

The delay of a connection estimated from the server results in a write block time against an output port of the server. A relaying device is disposed in the vicinity of the server where the delay is very small. Data written by the server is read at high speed by the relaying device using a large buffer. Data stored in the buffer is gradually transferred to a client having a large delay. Thus, the delay of the connection to the client is very small estimated from the server.

In a conventional network communication, a communication window that represents the amount of data that can be transmitted in one transfer session has been set. The maximum communication throughput is determined by the ratio of the window size and the delay time (window size/delay). However, it is assumed that the window size depends on the sizes of the buffers on the transmitting side and the receiving side and that the bandwidth of the network is sufficiently larger than the maximum communication throughput.

Thus, even if the delay of a communication is large, when the window size is large, the same throughput as a communication having a small delay can be obtained. As a result, in addition to the case of a relatively small object that can be stored to a buffer, the effective delay of an object that successively flows as steaming data is small estimated from the server.

In most cases, a throughput assigned by the server to a connection to each client is inversely proportional to the delay of the connection or the inner delay of the server whichever larger. The inner delay of the server depends on the queue wait time of a disc I/O (input/output), a network I/O, a CPU (Central Processing Unit), and so forth. As the queue becomes long because of many requests, the inner delay becomes large.

A large server distributes objects to many discs or accesses them in parallel by the striping method or the like. Thus, the wait time of the disk I/O can be minimized. The wait time of the network I/O can be decreased using a high speed LAN (Local Area Network) and WAN (Wide Area Network), multiple LAN adaptors, or the like. On the other hand, the wait time of the CPU queue can be decreased using a shared memory computer having multiple CPUs, clusters of multiple computers, or the like.

Since the prices of peripheral devices are drastically dropping, many servers sufficiently have such resources. Thus, the inner delays of the servers are becoming remarkably small. As a result, in many cases, a throughput is assigned to each client corresponding to the delay of a network.

Thus, according to the embodiment of the present invention, an agent relaying device is disposed in the vicinity of a server. The agent relaying device has a large buffer. The agent relaying device receives an object using such a buffer. Thus, the network delay of a client estimated from the server can be substantially decreased.

Since the delay estimated from the server is substantially decreased, a larger throughput can be assigned to a client using the system according to the embodiment than another client of which the total network delay is the same. In addition, even if a client accesses a server from the opposite side of the earth, the client has the same throughput as a client that accesses the server through a high speed LAN.

FIG. 2 is a schematic diagram showing the structure of such a communicating system. In the system shown in FIG. 2, an agent relaying device 13 is disposed between a web server 11 and a web client 12. A network delay between the server 11 and the client 12 is denoted by RTT₁. A network delay between the agent relaying device 13 and the server 11 is denoted by RTT₂. A network delay between the agent relaying device 13 and the client 12 is denoted by RTT₃.

However, a network delay represents a round trip time period during a transmitting side transmits a signal to a receiving side and the receiving side returns a response to the transmitting side. The relation of RTT₁=RTT₂+RTT₃ is satisfied. IF the data relaying overhead of the agent relaying device 13 is ignorably small against RTT₁.

Now, the inner delay of the server 11 is denoted by D. The window size of data transferred from the server 11 to the client 12 is denoted by B. In that case, the maximum download rate of which data is directly transferred from the server 11 to the client 12 is represented as the ratio of D or RTT₁ whichever larger and B. Thus, the maximum download rate can be expressed by B/max (D, RTT₁) (where max (a, b) represents the maximum value of a and b). Usually, since the relation of D<RTT₁ is satisfied, the maximum download rate is B/RTT₁.

When the agent relaying device 13 functions as a proxy client and relays data between the server 11 and the client 12. The maximum download rate that takes place between the server 11 and the agent relaying device 13 can be expressed by B/max (D, RTT₂).

When the agent relaying device 13 is disposed so that the relation of D<RTT₂ is satisfied, the maximum download rate that takes place between the server 11 and the agent relaying device 13 can be expressed by B/RTT₂. At that point, the maximum download rate estimated from the server 11 is (B/RTT₂)/(B/RTT₁)=RTT₁/RTT₂ times as large as that of the direct communication. In other words, the delay to the client 12 estimated from the server 11 is decreased from RTT₁ to RTT₂. In addition, the throughput assigned by the server 11 to the connection to the client 12 is increased RTT₁/RTT₂ times.

The maximum download rate that takes place between the agent relaying device 13 and the client 12 depends on the download rate that takes place between the server 11 and the agent relaying device 13 or the download rate that takes place between the agent relaying device 13 and the client 12 whichever smaller. Thus, the maximum download rate that takes place between the agent relaying device 13 and the client 12 can be expressed by min (B/RTT₃, B/max (D, RTT₂)) (where min (a, b) represents the minimum value of a and b).

When the agent relaying device 13 is disposed so that the relation of RTT₂< RTT₃ is satisfied, B/RTT₃ becomes smaller than B/max (D, RTT₂). Thus, the maximum download rate that takes place between the agent relaying device 13 and the client 12 can be expressed by B/RTT₃.

At that point, the maximum download rate estimated from the client 12 is (B/RTT₃)/(B/RTT₁)=RTT₁/RTT₃ times as large as that of the direct communication. Since the relation of RTT₃<RTT₁ is satisfied, the maximum download rate using the agent relaying device 13 is higher than that of the direct communication.

When the relation of D<RTT₂<RTT₃ is satisfied, the throughput assigned by the server 11 increases RTT₁/RTT₂ times. The maximum download rate estimated from the client 12 increases RTT₁/RTT₃=RTT₁/(RTT, −RTT₂) times. In other words, as RTT₂ becomes small, the throughput assigned by the server 11 becomes large. As RTT₂ becomes large, the maximum download rate of the client 12 becomes large.

Thus, the value of RTT₂ depends on a trade-off of the assigned throughput and the maximum download rate. In particular, when the agent relaying device 13 is disposed so that RTT₂ is close to D, the assigned throughput can be increased to up to RTT₁/D times as large as that of the direct communication.

Thus, according to the communicating system shown in FIG. 2, using the throughput. characteristic of the server, the client 12 can obtain a throughput that is larger than that of another client that accesses the server at the same time.

To suppress the delay of the communication protocol without need to modify both a server and a client, a system that has agent relaying devices may be disposed in the vicinities of the server and the client is available. In this system, these agent relaying devices perform protocol conversions. In most communication time, the system relays a communication between the server and the client corresponding to the converted protocol.

For example, a remote agent of each client is virtually disposed in an agent relaying device in the vicinity of the server. An application protocol of a connection between a client and a server is converted into a multiplexing protocol of a connection between an agent relaying device in the vicinity of the client and an agent relaying device in the vicinity of the server. Corresponding to such a protocol conversion, a huge communication window is set between the two agent relaying devices. Thus, the throughput between the client and the server improves. As a result, the throughput between the client and the server is improved and thereby the network delay is hidden.

Particularly, in a communication of which one request is transmitted and a response is received as with an HTTP (Hyper Text Transfer Protocol) communication, a relaying protocol having the theoretical maximum speed that allows a response object to be transmitted from a server to a client in one round trip time against a request that is transmitted from the client can be accomplished.

According to the relaying protocol, a huge TCP window is set for a TCP (Transmission Control Protocol) communication between agent relaying devices. An object of any size is placed in the window. The object is transmitted from the transmitting side to the receiving side at a time. The receiving side notifies the transmitting side that the receiving side has received the object using one acknowledge message.

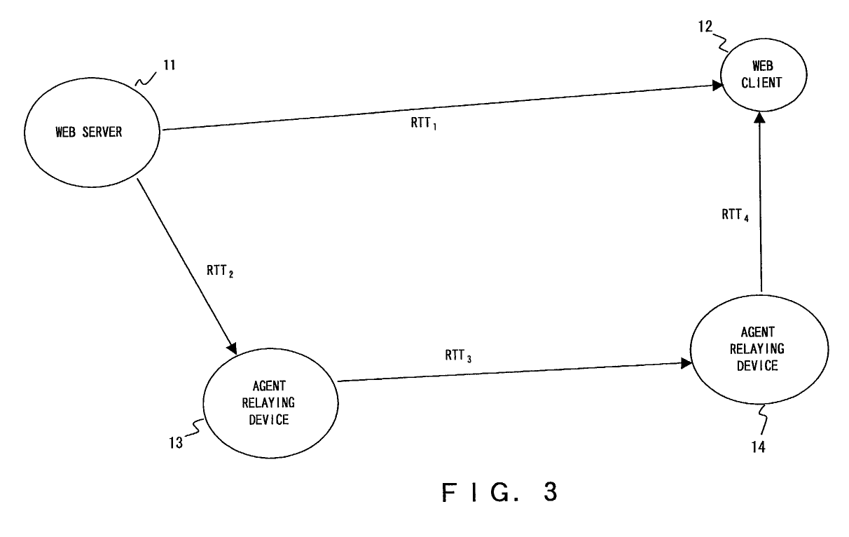

FIG. 3 is a schematic diagram showing the structure of such a communicating system. In the system shown in FIG. 3, an agent relaying device 13 is disposed in the vicinity of a server 11. An agent relaying device 14 is disposed in the vicinity of a client 12. A network delay between the server 11 and the client 12 is denoted by RTT₁. A network delay between the server 11 and the agent relaying device 13 is denoted by RTT₂. A network delay between the agent relaying device 13 and the agent relaying device 14 is denoted by RTT₃. A network delay between the agent relaying device 14 and the client 12 is denoted by RTT₄. In this example, the relation of RTT₁= RTT₂+RTT₃+RTT₄ is satisfied. In that case, it is assumed that the data relaying overheads of the agent relaying device 13 and the agent relaying device 14 are ignorably small against RTT₁.

Normally, the buffer size of the network I/O buffer assigned by the server 11 to one communication is around 8 KB (kilobytes). This is because the average size of an object transferred on WWW (World Wide Web) is around 10 to 20 KB. Corresponding to a TCP congestion avoidance algorithm, the window is gradually opened for 3 KB, 6 KB, 12 KB, . . . Thus, even if the buffer size of the I/O buffer is increased, the buffer size that is actually used is around 8 KB.

When large binary data is transferred, a large buffer is effective. However, the area exceeding 8 KB is not usually used. It is wasteful to assign a too large buffer.

As a method for effectively increasing the I/O buffer, a connection with a largely open windows is multiplexed and shared by other connections or other clients. In this method, since the window is large, the effective throughput is high and used for transferring data of other connections. Even if small objects are often transferred, they are packed together in the window and transferred. Thus, even if a large buffer is allocated, it is not substantially wasteful.

In this method, since data is relayed by two agent relaying devices 13 and 14, these overheads are inevitably included. When hardware and software are improved, the overheads can be reduced. On the other hand, the physically absolute delay cannot be decreased by improving hardware and software unless an ultra light speed communicating means is accomplished.

To set such a communication window, a connection is made between the agent relaying devices 13 and 14 corresponding to a highly reliable communication transport protocol using a large I/O buffer. A communication corresponding to an application protocol is relayed (tunneled) with a connection between the server 11 and the client 12 using a multiplexing protocol of the connection.

The agent relaying devices 13 and 14 convert packets or data into multiplexed packets (that are more effective than the original packets) corresponding to the characteristics of their application protocol rather than directly relaying packets in the transport layer. At that point, an agent of the client 12 is disposed as a program module of each of the agent relaying devices 13 and 14. The agent of the client 12 functions as an interface for converting and inversely converting the application protocol to the multiplexed protocol or vice versa.

While the agent of the agent relaying device 13 receives an object from the server 11 on behalf of the client 12 at high speed using a large buffer, the agent transfers an object stored in the buffer to the agent of the agent relaying device 14 corresponding to the multiplexing protocol. The agent of the agent relaying device 14 converts the multiplexing protocol of the object into an application protocol for communicating with the client 12 and transfers the converted object to the client 12.

On the other hand, while the agent of the agent relaying device 14 is receiving an object transmitted by the client 12 using a large buffer, the agent of the agent relaying device 14 transfers the object to the agent of the agent relaying device 13 corresponding to the multiplexing protocol. While the agent of the agent relaying device 13 is receiving the transferred object using a large buffer, the agent of the agent relaying device 13 transfers the object stored in the buffer to the server 11.

When a transport protocol packet is simply relayed corresponding to the multiplexing protocol, the network delay increases by the relayed overhead. However, when the protocol is converted into the above-described application protocol, the network delay can be substantially decreased (hidden). In this example, the transport protocol packet corresponds to an IP (Internet Protocol) packet or the like.

The protocol conversion in the application protocol level is performed by converting the window size of a data transfer window for a reliable communication such as TCP. Since the maximum communication rate of a reliable communication is determined by the ratio of the window size and the delay (window size/delay) Thus, the window size of a region with a large delay is increased so that the communication rate is the same as a region having a small delay. However, it is assumed that the bandwidth of the network is sufficiently large and thereby does not affect the maximum communication rate.

In TCP or the like, to avoid congestion, a slow start operation is performed. In the slow start operation, the window size is gradually increased after data is transferred. In the slow start operation, the window is set for each connection corresponding to the data transfer protocol such as TCP in a lower level of the application protocol. The window is gradually opened. When one connection is continuously used and a transfer error does not take place, the window size of the connection is doubled whenever each packet is successfully transferred. The window is exponentially opened from the small initial value to the designated maximum size.

When a connection corresponding to a low level protocol is continuously used, as long as a transfer error does not take place, the window of the connection corresponding to the low level protocol can be opened in the maximum size. Even if a transfer error takes place, when the low level protocol automatically adjusts the window size, the window size is set to the maximum size in which a transfer error hardly takes place. In that case, the continuous use of the connection corresponding to the low level protocol is referred to as multiplexing of connections.

Just after multiplexed connections corresponding to a high level protocol are used, since the window of a connection corresponding to a low level protocol is not sufficiently opened. Thus, the multiplexed connections corresponding to the high level protocol are affected by the slow start of the connection corresponding to the low level protocol. However, since the window is exponentially opened, it is sufficiently opened in a short time. As a result, the multiplexed connections use a connection corresponding to the low level protocol that is sufficiently opened.

When a connection whose window is largely opened is multiplexed, since a communication is relayed with the maximum window size, the slow start operation does not substantially work for a communication between the server 11 and the client 12. In addition, since a congestion control works for multiplexed connections, they do not adversely congest.

On the other hand, when a multiplexed connection is not used, since a connection corresponding to a low level protocol is newly set, the slow start operation of the connection corresponding to the low level protocol directly affects a connection corresponding to a high level protocol.

Corresponding to TCP, to open a window for the maximum size of 8 KB, an object of 17 KB or more should be downloaded. However, the typical size of an object on WWW or the like is around 3 KB, the performance of a connection corresponding to a low level protocol is not sufficiently used.

For example, in the case that 10 objects of 3 KB each are successively downloaded using a multiplexed connection, when 6 objects are downloaded, the window is opened for 8 KB. Thereafter, the remaining objects are transferred with the window. On the other hand, when connections are not multiplexed, since the window is opened for each object, the window is not opened for 8 KB.

As described above, in a communication between the agent relaying devices 13 and 14, with only a multiplexed connection corresponding to a high level protocol, since the window is always fully opened, the slow start operation does not work. When the maximum window size of a connection corresponding to a low level protocol is initialized to 100 times larger than the standard value, the window can be opened to a size that is not available in the normal state as long as the multiplexed connection is continuously used.

Normally, regardless of the bandwidth of a network, the transfer rate is determined by the ratio of the window size and the delay (namely, window size/delay). Thus, unless the window size is sufficiently large, even if a large investment is made in network resources, they will not be effectively used. From that point of view, by multiplexing a connection corresponding to a high level protocol, one method for easily increasing the substantially average window size is accomplished.

As with the system shown in FIG. 2, in the system shown in FIG. 3, when data is directly transferred from the server 11 to the client 12, the maximum download rate can be expressed by B/max (D, RTT₁)

When an object is relayed by the agent relaying devices 13 and 14, the maximum download rate that takes place between the server 11 and the agent relaying device 13 can be expressed by B/max (D, RTT₂).

In addition, the window size W of a data transfer between the agent relaying devices 13 and 14 can be freely set independently from the buffer sizes of the server 11 and the client 12, the window size W is set to a value that is for example several to several thousands times larger than B.

The maximum download rate that takes place between the agent relaying devices 13 and 14 depends on the download rate that takes place between the server 11 and the agent relaying device 13 or the download rate that takes place between the agent relaying devices 13 and 14, whichever smaller. Thus, the maximum download rate that takes place between the agent relaying devices 13 and 14 can be expressed by min (W/RTT₃, B/max (D, RTT₂))

On the other hand, the maximum download rate that takes place between the agent relaying device 14 and the client 12 depends on the download rate that takes place between the server 11 and the agent relaying device 13, the download rate that takes place between the agent relaying devices 13 and 14, or the download rate that takes place between the agent relaying device 14 and the client 12 whichever the lowest rate. Thus, the maximum download rate that takes place between the agent relaying device 14 and the client 12 can be expressed by min (B/RTT₄, W/RTT₃, B/max (D, RTT₂)

In that case, when the agent relaying devices 13 and 14 are disposed so that the relations of D< RTT₂<RTT₃ and RTT₄<RTT₃ are satisfied and that the relation of W=B×(RTT₃/RTT₂) is satisfied, the maximum download rate that takes place between the agent relaying devices 13 and 14 can be expressed by B/RTT₂. The maximum download rate that takes place between the agent relaying device 14 and the client 12 can be expressed by min (B/RTT₄, B/RTT₂)

If making the relation of RTT₂≧RTT₄ be satisfied, the maximum download rate that takes place between the agent relaying device 14 and the client 12 can be expressed by B/RTT₂. At that point, the maximum download rate estimated from the client 12 is (B/RTT₂)/(B/RTT₁)=RTT₁/RTT₂ times as large as that of the direct communication. Since the relation of RTT₂<RTT₁ is normally satisfied, the download rate in the case that the agent relaying devices 13 and 14 are used is higher than the case of the direct communication.

In particular, when the agent relaying devices 13 and 14 are disposed adjacent to the server 11 and the client 12, the values of RTT₁ and RTT₃ become the same and the value of RTT₂ is much smaller than the value of RTT₁. At that point, the value of W is much larger than the value of B. The maximum download rate estimated from the client 12 is much higher than that of the direct communication. Thus, the throughput between the server 11 and the client 12 remarkably increases.

In the system shown in FIG. 3, the agents of the agent relaying devices 13 and 14 can not only maximally increase the throughput, but maximally decrease it.

When the agent relaying devices 13 and 14 perform an idling operation at proper timings, data transferring operation is throttled. At that point, the agent relaying devices 13 and 14 schedule the idling operations performed by agents of many clients and assign resources to the individual clients. Thus, the agent relaying devices 13 and 14 can intentionally control throughputs assigned by the system to the individual clients.

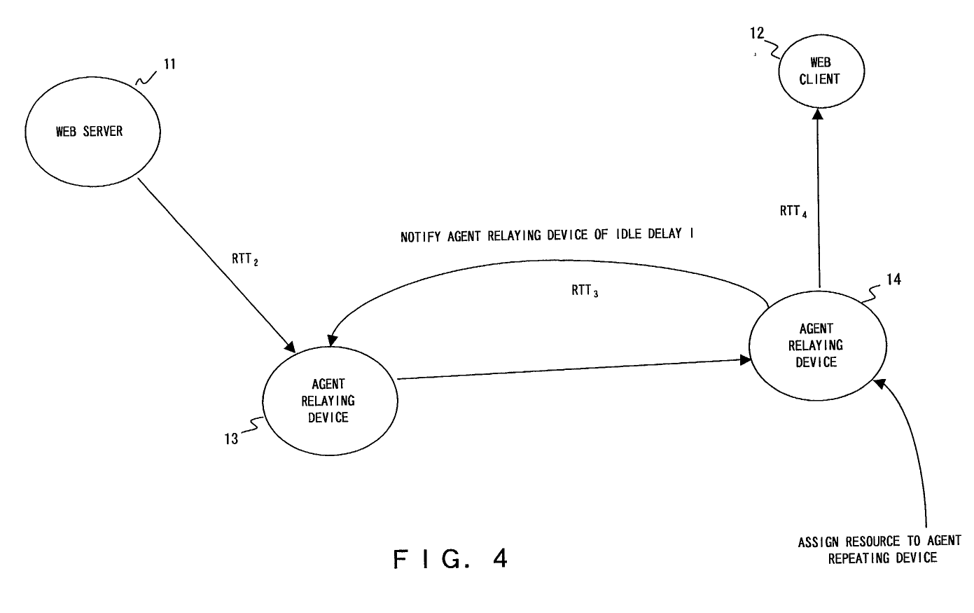

FIG. 4 shows such a throttle control. A proper throughput value is pre-assigned as a resource to the agent of an agent relaying device 14 on the client side. The agent of the agent relaying device 14 converts the value into idling time I and notifies an agent of an agent relaying device 13 of the idling time I. Whenever the agent of the agent relaying device 13 transfers data, the agent executes the idling operation at period I.

It is assumed that the agent relaying device 13 receives data from a server 11, returns an OK reception notification (acknowledgement) to the server 11, and then performs the idling operation. In that case, the maximum download rate that takes place between the server 11 and the agent relaying device 13 is determined by the ratio of the maximum time of D, RTT₂, and I and B. Thus, the maximum download rate that takes place between the server 11 and the agent relaying device 13 can be expressed by B/max (D, RTT₂, I).

In addition, the maximum download rate that takes place between the agent relaying devices 13 and 14 can be expressed by min (W/RTT₃, B/max (D, RTT₂, I)). The maximum download rate that takes place between the agent relaying device 14 and the client 12 can be expressed by min (B/RTT₄, W/RTT₃, B/max (D, RTT₂, I).

If the relations of W=B×(RTT₃/RTT₂), I> D, I>RTT₂, and I>RTT₄ are satisfied, the maximum download rate that takes place between the agent relaying device 14 and the client 12 can be expressed by B/I. At that point, the maximum download rate estimated from the client 12 is (B/I)/(B/RTT₁)=RTT₁/I times as large as that of the case of the direct communication.

Thus, when the relation of I<RTT₁ is satisfied, the throughput is larger than that of the case of the direct communication. In contrast, when the relation of I>RTT₁ is satisfied, the throughput is smaller than that of the case of the direct communication. Thus, the throughput of each client can be increased and decreased. As a result, a data transferring operation corresponding to the priority of a client can be accomplished.

Next, an example of a service based on the system shown in FIG. 3 will be described. In the system shown in FIG. 3, when a delay that takes place between two networks is large, an agent relaying device is disposed between these networks. As a result, a high rate virtual tunnel using a multiplexed connection is formed. Since the virtual tunnel is used as a bypass, the delay that takes place between the networks can be substantially hidden. Thus, a service that assures a high throughput to a premium user who pays a special fee can be accomplished.

In the service, IP addresses of individual users are pre-registered to an agent relaying device on the client side. An agent of the agent relaying device compares an IP address of a client who tries to make a connection with an IP address that has been registered so as to perform a user authenticating process. When the IP address of the client has been registered, the process is continued. Otherwise, the process is terminated and the connection is shut off.

At that point, the agent relaying device on the client side performs an operation equivalent to a proxy server. Only when a communication is performed at high rate using an agent relaying device on the server side, the agent relaying device on the client side relays a request to the agent relaying device on the server side. Otherwise, the agent relaying device on the client side functions as a proxy server and directly connects the request to the server.

In the case of an HTTP communication, the user authenticating process can be performed using a cookie rather than an IP address. The cookie is a technology of which a web site provider temporarily writes data to a client who visited the site and stores the data. A cookie stores information about a user, date and time at which the user visited the site, the number of times the user visited the site, and so forth.

In that case, cookies are pre-delivered to individual users. When a user accesses the network, the cookie is set at the header of a HTTP request. In addition, cookies of individual users are pre-registered to the agent relaying device on the client side. The agent of the agent relaying device checks for the header of the HTTP request of each client. When the header of the HTTP request contains a registered coolie, the agent continues the process. Otherwise, the agent terminates the process and shuts off the connection.

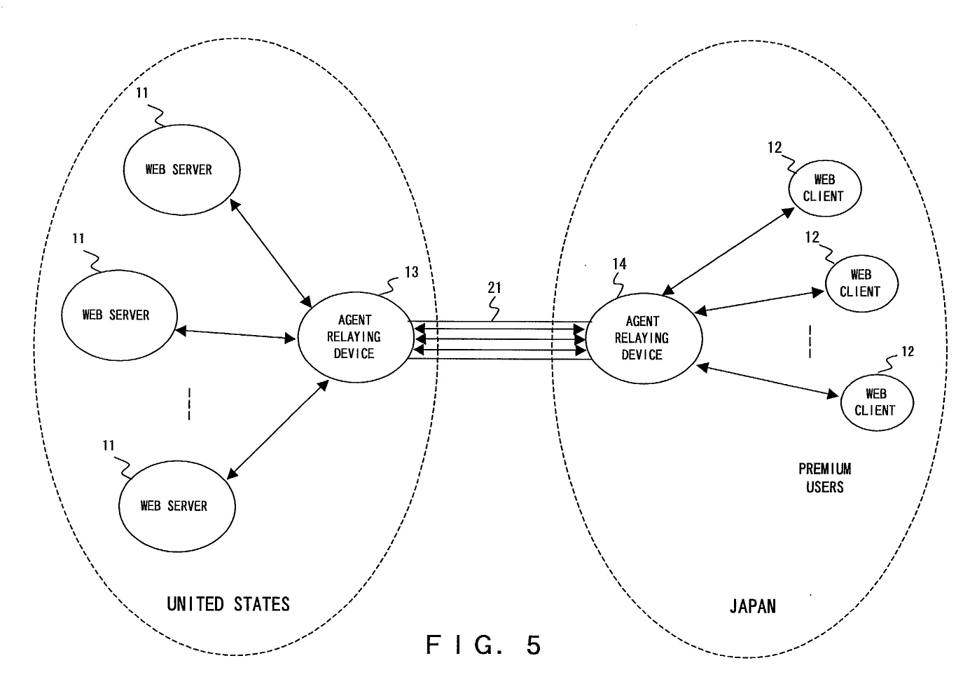

FIG. 5 shows the structure of a communicating system that performs such a premium user service. When multiple clients 12 as premium users in Japan receive services from multiple servers 11 in United States, agent relaying devices 13 and 14 are disposed at proper positions in United States and Japan. Normally, multiple agent relaying devices 13 and agent relaying devices 14 are disposed. Using multiplexed connections, a virtual tunnel 21 is formed between the agent relaying devices 13 and 14 so that an application protocol is virtually tunneled.

A Japanese premium user sets the agent relaying device 14 as a proxy server and accesses a server 11 disposed in United States. When the agent relaying device 14 receives a request from the client 12, the agent relaying device 14 causes an agent of the client 12 to perform an accessing control and a charging control.

Using an IP address, a cookie, and so forth, the agent authenticates and charges the client 12 for each connection so as to determine whether the client 12 is a premium user who is pre-registered. When the client 12 has been successfully authenticated, the agent transfers the request to an appropriate one of multiple agent relaying devices 13 disposed in United States. When the client 12 has not been successfully authenticated, the agent simply discards the request and erases the connection.

A routing table of the agent relaying device 14 pre-registers the servers 11 and the agent relaying device 13 disposed in United States. The agent of the client 12 searches the routing table so as to route the appropriate agent relaying device 13. Routing information is dynamically exchanged between the agent relaying devices 13 and 14. Thus, the routing table is dynamically updated.

When the agent relaying device 13 has received the request, the agent relaying device 13 causes the agent of the client 12 to send the request to the server 11. The server 11 transfers the requested object to the client 12 through the inverse route.

In the service, when the agent of the agent relaying device 14 charges a client while authenticating it, the agent can charge the user for a quantity basis fee corresponding to the number of packets transferred. Alternatively, the agent may charge the user for a flat basis fee as a service fee for a predetermined time period.

In the premium user service, a client 12 who has transmitted a connection request is identified. A validity for a connection between the client 12 and the virtual tunnel 21 is determined. A premium service that allows a throughput to be increased through the virtual tunnel 21 is provided to a client 12 who has been performed for the connection request.

In particular, a network delay that takes place between United States and Japan is very large compared with that in United States or in Japan. Thus, when the bandwidth can be sufficiently increased with the premium user service, it can be expected that a communication rate ten times or more larger than that of the case that a client 12 in Japan directly communicates with a server 11 in United States.

In addition, a network delay is substantially hidden with the virtual tunnel 21. Thus, a service for assuring a large throughput for a communication between a server 11 of a service provider who pays a service fee and a client 12 as a user can be provided.

When a service provider cannot afford an investment in mirror servers that are distributed worldwide, using the virtual tunnel 21, a service equivalent to the case that mirror servers are distributed can be accomplished at low cost.

In that case, the agent relaying devices 13 and 14 relay a communication between a server 11 of a service provider who has paid a predetermined service fee and a client 12. In reality, the agent relaying devices 13 and 14 relay only a request for an object from a client to a server 11 of a provider who has paid the predetermined service fee. The agent relaying devices 13 and 14 refuse a request for an object from a client to the other servers.

At that point, while the agent relaying device 14 on the client side is performing an operation equivalent to the remote server 11, the agent relaying device 14 transfers a request to an object of the server 11. Thus, from a view point of the client 12, the agent relaying device 14 performs the same operation as a mirror server. Thus, it is not necessary to change settings of the client 12.

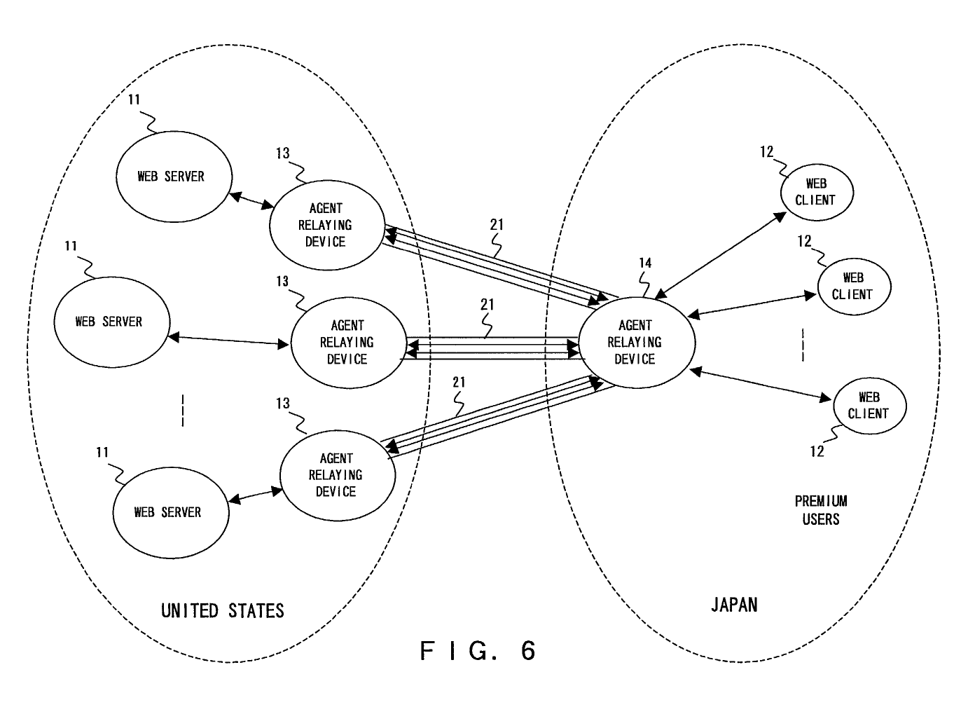

FIG. 6 shows the structure of a communicating system that performs such a client mirroring service. In the system, an agent relaying device 13 dedicated to a server 11 that is registered as a contracted server is disposed in United States. Each agent relaying device 13 and an agent relaying device 14 disposed in Japan are connected with a virtual tunnel 21 corresponding to an application protocol. Normally, multiple agent relaying devices 14 are disposed.

The agent relaying device 14 is open as a mirror server to users in Japan. The routing table of the agent relaying device 14 pre-registers pairs of servers 11 and agent relaying devices 13. When the agent relaying device 14 receives a request from a client 12 and searches the routing table for a server 11 that has a service for a requested object. The agent relaying device 14 selects an agent relaying device 13 connected to the server 11 as a destination and transfers the request to the agent relaying device 13.

When the agent relaying device 13 has received the request, it causes the agent to perform the accessing control and the charging control. The agent authenticates and charges the server 11 and determines whether or not the destination of the transferred request is the server 11 connected to the agent relaying device 13.

When the server 11 has been successfully authenticated, the agent relaying device 13 transfers the request to the server 11. When the server 11 has not been successfully authenticated, the agent relaying device 13 returns a notification that represents that the requested object does not exist to the client 12. Thus, the agent relaying device 13 can refuse a request that is transferred due to a malfunction of a program or the like.

In the service, while the agent of the agent relaying device 13 is authenticating the server, the agent charges the server. Thus, as with the service shown in FIG. 5, the system can charge the service provider for a quantity basis fee. Alternatively, the system may charge the service provider for a flat basis fee.

Thus, in the client mirroring service, a destination server 11 is identified. It is determined whether or not to connect the server 11 and the client 12 through a virtual tunnel 21. A service that has the same effect as a mirror server can be provided to the permitted client 12 through the virtual tunnel 21. As with the service shown in FIG. 5, in the service, it can be expected that the transfer rate 10 times or more higher than that of the case of the direct communication.

Next, with reference to FIGS. 7 to 10, the structure and operation of the agents activated in the agent relaying devices 13 and 14 will be described in detail.

FIG. 7 is a block diagram showing the structure of an agent relaying device. The agent relaying device shown in FIG. 7 is composed of a computer. The agent relaying device comprises receiving modules 31 and 41, protocol converting modules 32 and 39, multiplexing modules 33 and 40, transmitting modules 34 and 38, an authenticating and charging portion 35, a switch module 36, and a routing table 37. These modules are disposed as for example program modules. The protocol converting modules 32 and 39 correspond to an agent that performs a process on behalf of the client 12.

First of all, the agent relaying device 14 on the client side receives an application protocol packet as a request from the client 12 through the network and transfers the received packet to the protocol converting module 32.

In the case of the premium user service, the protocol converting module 32 requests the authenticating and charging portion 35 for the authenticating and charging process for a transmission source of the packet and receives the processed results therefrom. Thereafter, the protocol converting module 32 converts the application protocol packet into an agent protocol packet and transfers the agent protocol packet to the switch module 36. The agent protocol corresponds to a multiplexing protocol used between agent relaying devices.

The switch module 36 searches the routing table 37 for a route of the destination, determines the route of the destination, and transfers the agent protocol packet to the multiplexing module 33.

The multiplexing module 33 multiplexes agent protocol packets of multiple connections. The transmitting module 34 transmits the multiplexed packets to the agent relaying device 13 on the server side through the network.

The receiving module 41 of the agent relaying device 13 receives the multiplexed packets from the network. The multiplexing module 40 demultiplexes the multiplexed packets to agent protocol packets and transfers each agent protocol packet to the switch module 36.

The switch module 36 searches the routing table 37 for a route of the destination and transfers an agent protocol packet to the protocol converting module 39.

The protocol converting module 39 converts the received agent protocol packet into an application protocol packet. In the client mirroring service, the protocol converting module 39 requests the authenticating and charging portion 35 for the authenticating and charging process for the destination server and receives the processed results therefrom. Thereafter, the protocol converting module 39 transfers the application protocol packet to the transmitting module 38. The transmitting module 38 transmits the application protocol packet to the destination server 11 through the network.

Thereafter, the receiving module 31 of the agent relaying device 13 receives the application protocol packet as an object of the server 11 from the network and transfers the received packet to the protocol converting module 32.

The protocol converting module 32 converts the application protocol packet into an agent protocol packet and transfers the agent protocol packet to the multiplexing module 33 through the switch module 36. The multiplexing module 33 multiplexes agent protocol packets of multiple connections. The transmitting module 34 transmits the multiplexed packets to the agent relaying device 14 through the network.

Next, the receiving module 41 of the agent relaying device 14 receives the multiplexed packets from the network. The multiplexing module 40 demultiplexes the multiplexed packets into agent protocol packets and transfers each agent protocol packet to the protocol converting module 39 through the switch module 36.

The protocol converting module 39 converts the received packet into an application protocol packet and transfers the application protocol packet to the transmitting module 38. The transmitting module 38 transmits the application protocol packet to the destination client 12 through the network.

Thus, the requested object is downloaded to the client 12 that has requested the server 11 for the object through the agent relaying devices 13 and 14.

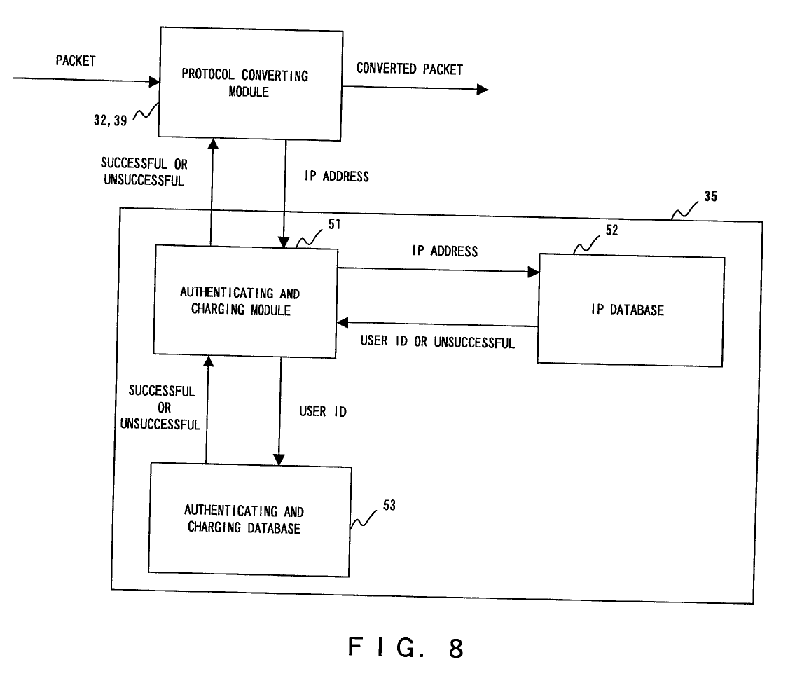

FIG. 8 is a block diagram showing the structure of the authenticating and charging portion 35. The authenticating and charging portion 35 shown in FIG. 8 comprises an authenticating and charging module 51, an IP database 52, and an authenticating and charging database 53. The authenticating and charging portion 35 performs the authenticating and charging process corresponding to an IP address assigned to each packet.

In the premium user service, the IP database 52 stores records of individual clients 12. Each record is composed of an IP address and user identification information (user ID) of each client 12. The authenticating and charging database 53 stores records each of which is composed of a user ID, a service expiration date, and the number of processed packets.

The protocol converting module 32 transfers an IP address of a transmission source of an application protocol packet to the authenticating and charging module 51. The authenticating and charging module 51 searches the IP database 52 for a record that contains the IP address and obtains the user ID of the record.

Next, the authenticating and charging module 51 searches the authenticating and charging database 53 for a record that contains the obtained user ID and checks for the service expiration date of the record. When the record is not expired, the authenticating and charging module 51 adds “1” to the number of packets of the record and notifies the protocol converting module 32 that the user has been successfully authenticated.

When the IP database 52 does not store a record that contains the IP address of the transmission source or when the record is expired, the authenticating and charging module 51 notifies the protocol converting module 32 that the user has not been successfully authenticated.

In the client mirroring service, the IP database 52 stores records of individual servers 11. Each of the records is composed of an IP address and service provider identification information (service provider ID) of each server 11. The authenticating and charging database 53 stores records each of which is composed of a service provider ID, a service expiration date, and the numbers of processed packets.

The protocol converting module 39 transfers the IP address of the transmission destination of the application protocol packet to the authenticating and charging module 51. The authenticating and charging module 51 performs the same process as the premium user service and notifies the protocol converting module 39 whether or not the server has been successfully authenticated. In that case, the user service ID that the same function as the user ID.

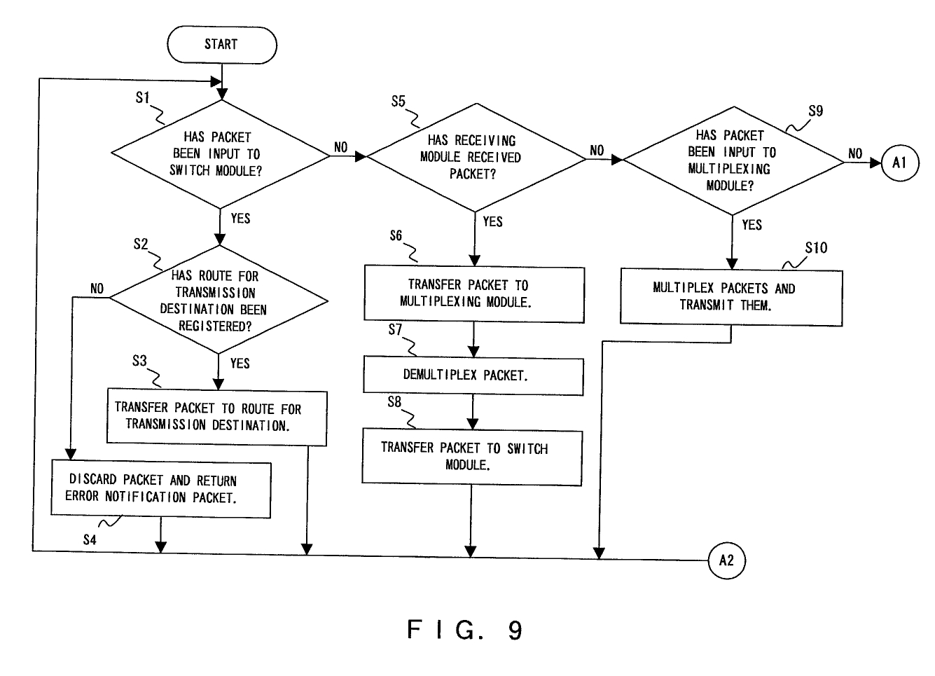

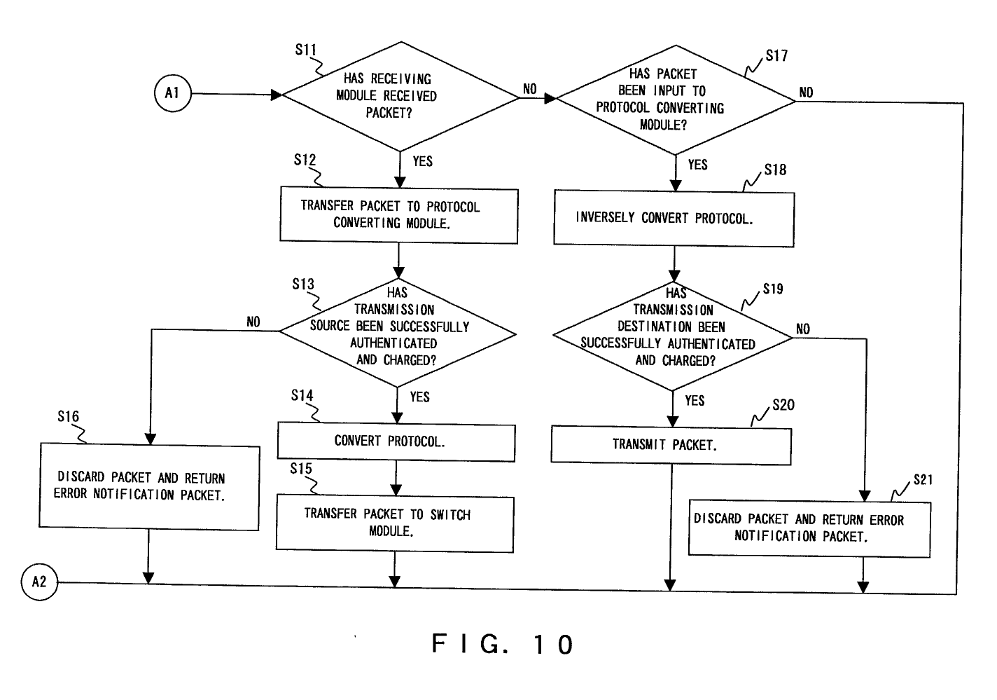

FIGS. 9 and 10 are a first part and a second part of a process of the agent relaying device shown in FIG. 7. When each module receives a packet to be processed from the network or when a packet to be processed is input from another module, each module performs a predetermined process.

The switch module 36 determines whether or not an agent protocol packet has been input from the protocol converting module 32 or the multiplexing module 40 (at step S1 in FIG. 9). When the determined result at step S1 is Yes (namely, the packet has been input), the switch module 36 searches the routing table 37 for a route of the transfer destination and determines whether or not the route has been registered (at step S2). When the determined result at step S2 is Yes (namely, the route has been registered), the switch module 36 transfers the packet to the route (at step S3). Thereafter, the process is repeated from step S1.

Normally, the packet that has been input from the protocol converting module 32 is transferred to the multiplexing module 33. The packet that has been input from the multiplexing module 40 is transferred to the protocol converting module 39. When the determined result at step S2 is No (namely, the route has not been registered), the switch module 36 discards the packet and returns an error notification packet to the transmission source (at step S4). Thereafter, the process is repeated from step S1.

When the determined result at step S1 is No (namely, an agent protocol packet has not been input), the receiving module 41 determines whether or not an agent protocol packet has been received from the network (at step S5). When the determined result at step S5 is Yes (namely, an agent protocol packet has been received), the receiving module 41 transfers the packet to the multiplexing module 40 (at step S6). The multiplexing module 40 demultiplexes the packet (at step S7) and transfers the demultiplexed packets to the switch module 36 (at step S8). Thereafter, the process is repeated from step S1.

When the determined result at step S5 is No (namely, the receiving module 41 has not received an agent protocol packet), the multiplexing module 33 determines whether or not an agent protocol packet has been input from the switch module 36 (at step S9). When the determined result at step S9 is Yes (namely, an agent protocol packet has been input), the multiplexing module 33 multiplexes agent protocol packets and transfers the multiplexed agent protocol packets to the transmitting module 34 (at step S10). The transmitting module 34 transmits the packets to the network. Thereafter, the process is repeated from step S1.

When the determined result at step S9 is No (namely, an agent protocol packet has not been input to the multiplexing module 33), the receiving module 31 determines whether or not an application protocol packet has been received from the network (at step S11 in FIG. 10). When the determined result at step S11 is Yes (namely, an application protocol packet has been input), the receiving module 31 transfers the packet to the protocol converting module 32 (at step S12).

The protocol converting module 32 requests the authenticating and charging portion 35 for the authenticating and charging process for the transmission source of the packet and determines whether or not the transmission source has been successfully authenticated and charged (at step S13). When the determined result is Yes (namely, the transmission source has been successfully authenticated and charged, the protocol converting module 32 converts the packet into an agent protocol packet and transfers the agent protocol packet to the switch module 36 (at step S15). Thereafter, the process is repeated from step S1.

When the determined result at step S13 is No (namely, the transmission source has not been successfully authenticated and charged), the protocol converting module 32 discards the packet and returns an error notification packet to the transmission source through the switch module 36 (at step S16). Thereafter, the process is repeated from step S1.

When the determined result at step S11 is No (namely, the receiving module 31 has not received an application protocol packet), the protocol converting module 39 determines whether or not an agent protocol packet has been input from the switch module 36 (at step S17). When the determined result at step S17 is Yes (namely, an agent protocol packet has been input), the protocol converting module 39 inversely converts the packet into an application protocol packet (at step S18) and requests the authenticating and charging portion 35 for the authenticating and charging process for the transmission destination so as to determine whether or not the transmission destination has been successfully authenticated and charged (at step S19).

When the determined result at step S19 is Yes (namely, the transmission destination has been successfully authenticated and charged), the authenticating and charging portion 35 transfers the packet to the transmitting module 38. The transmitting module 38 transmits the packet to the network (at step S20). Thereafter, the process is repeated from step S1.

When the transmission destination has not been successfully authenticated, the authenticating and charging portion 35 discards the packet and returns an error notification packet to the transmission source through the switch module 36 (at step S21) Thereafter, the process is repeated from step S1.

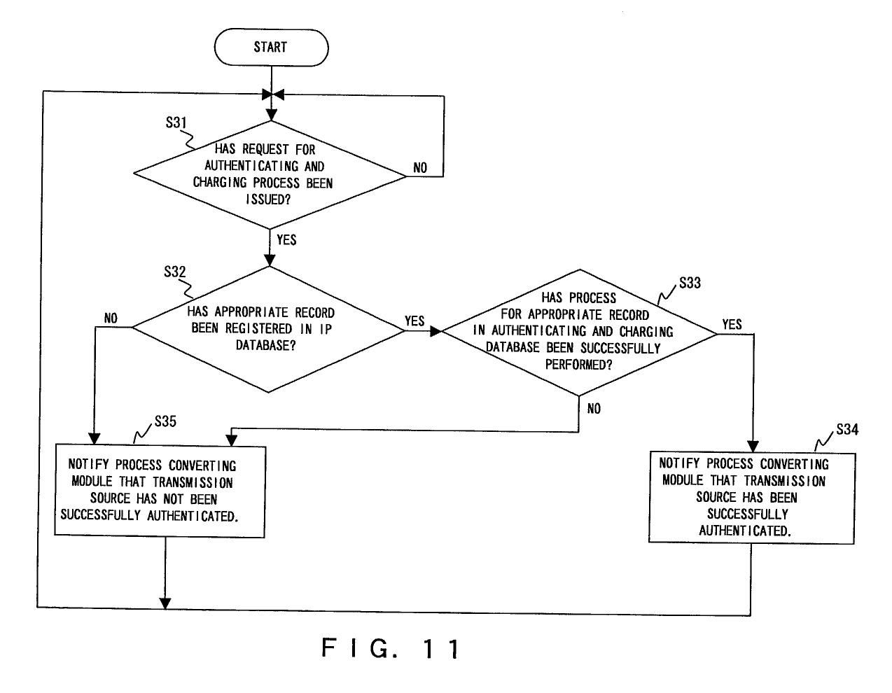

FIG. 11 is a flow chart showing the process of the authenticating and charging module 51 shown in FIG. 8. The authenticating and charging module 51 determines whether or not a request for the authenticating and charging process has been issued from the protocol converting module 32 or 39 (at step S31).

When the determined result at step S31 is Yes (namely, a request for the authenticating and charging process has been issued from the protocol converting module 32), the authenticating and charging module 51 searches the IP database 52 for a record that contains an IP address of the transmission source contained in the packet and determines whether or not the IP database 52 stores the record (at step S32).

When the determined result at step S32 is Yes (namely, the record is stored in the IP database 52), the authenticating and charging module 51 searches the authenticating and charging database 53 for a record that contains a user ID corresponding to the IP address, processes the record, and determines whether or not the processed result is valid (at step S33). In the process, the authenticating and charging module 51 checks for the expiration date contained in the record. When the expiration date does not exceed the current date and time, the authenticating and charging module 51 adds “1” to the number of packets contained in the record.

When the determined result at step S33 is Yes (namely, the process has been successfully performed), the authenticating and charging module 51 notifies the protocol converting module 32 that the transmission source has been successfully authenticated (at step S34). Thereafter, the process is repeated from step S31.

When the determined result at step S32 is No (namely, an appropriate record is not stored in the IP database 52) or when the process for the appropriate record has not been successfully performed, the authenticating and charging module 51 notifies the protocol converting module 32 that the destination source has not been successfully authenticated (at step S35). At step S33, when an appropriate record is not stored or when the expiration date of the record exceeds the current date, the authenticating and charging module 51 determines that the process for the record has not been successfully performed. Thereafter, the process is repeated after step S31.

When the determined result at step S31 is Yes (namely, the request for the authenticating and charging process has been issued from the protocol converting module 39), the authenticating and charging module 51 searches the IP database 52 for an IP address of the transmission destination contained in the request. The authenticating and charging module 51 obtains a service provider ID instead of a user ID. The authenticating and charging module 51 performs a similar process for the user ID and notifies the protocol converting module 39 of the result.

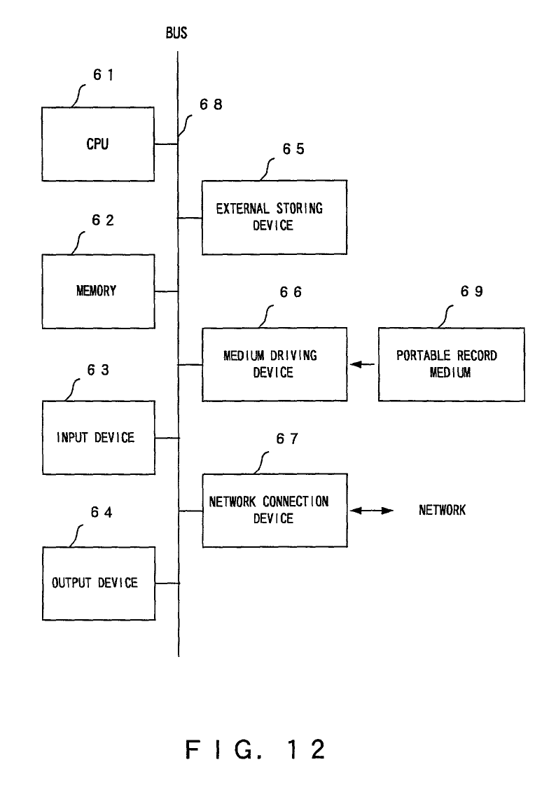

The server 11, the client 12, and the agent relaying devices 13 and 14 shown in FIG. 3 can be composed of an information processing device (computer) shown in FIG. 12. The information processing device shown in FIG. 12 comprises a CPU (Central Processing Unit) 61, a memory 62, an input device 63, an output device 64, an external storing device 65, a medium driving device 66, and a network connecting device 67 each of which is connected by a bus 68.

The memory 62 includes for example a ROM (Read Only Memory), a RAM (Random Access Memory), and so forth. The memory 62 stores programs and data that are used for processes. The routing table 37 shown in FIG. 7 and the IP database 52 and the authenticating and charging database 53 shown in FIG. 8 are stored in for example the memory 62. The CPU 61 executes a program using the memory 62 so as to perform a required process.

The receiving modules 31 and 41, the protocol converting modules 32 and 39, the multiplexing modules 33 and 40, the transmitting modules 34 and 38, and the switch module 36 shown in FIG. 7 and the authenticating and charging module 51 shown in FIG. 8 are stored as software components described by a program to the memory 62.

The input device 63 is for example a keyboard, a pointing device, a touch panel, and so forth. The input device 63 is used to input a command and information from an operator (a user, a service provider, a supervisor, or the like). The output device 64 is for example a display, a printer, a speaker, and so forth. The output device 64 is used to output a prompt and processed results to the operator.

The external storing device 65 is for example a magnetic disc device, an optical disc device, a magneto-optical disc device, a tape device, and so forth. The information processing device stores the above-described programs and data to the external storing device 65. When necessary, the information processing device loads the programs and data from the external storing device 65.

The medium driving device 66 drives the portable record medium 69 and accesses the contents thereof. The portable record medium 69 is a record medium whose contents can be read by any computer. The portable record medium 69 is for example a memory card, a floppy disk, a CD-ROM (Compact Disk Read Only Memory), an optical disc, a magneto-optical disc, and so forth. The operator stores the above-described programs and data to the portable record medium 69. When necessary, the programs and data stored in the portable record medium 69 are loaded to the memory 62.

The network connecting device 67 is used to connect the information processing device to a communication network. The information processing device receives the above-described programs and data from another device through the network connecting device 67. When necessary, the programs and data are loaded from the network connecting device 67 to the memory 62.

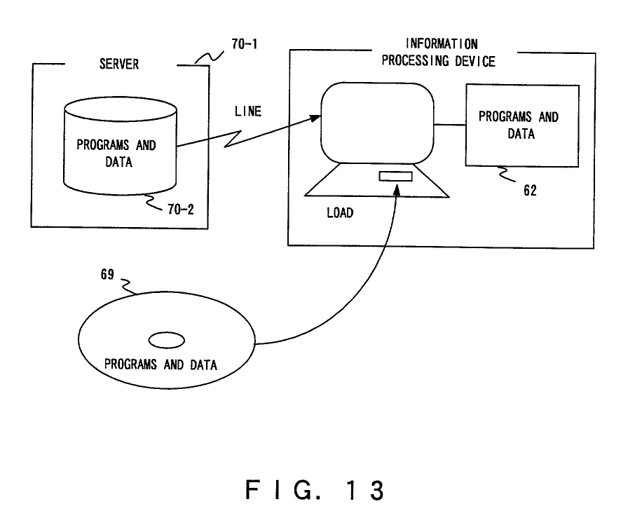

FIG. 13 is a schematic diagram showing a record medium from which a computer can read and that allows programs and data to be supplied to the information processing device shown in FIG. 12. The programs and data stored in the portable record medium 69 and a database 70-2 of a server 70-1 are loaded to the memory 62. At that point, the server 70-1 generates a transfer signal for transferring programs and so forth and transmits the transfer signal to the information processing device through any transferring medium on the network. The CPU 61 executes the programs using the data and performs a required process.

According to the above-described embodiment, the agent relaying devices 13 and 14 are disposed separately from the server 11 and the client 12, respectively. Alternatively, the agent relaying devices 13 and 14 may be built in the server 11 and the client 12, respectively. In reality, it is preferred to integrate the agent relaying device 13 with the server 11.

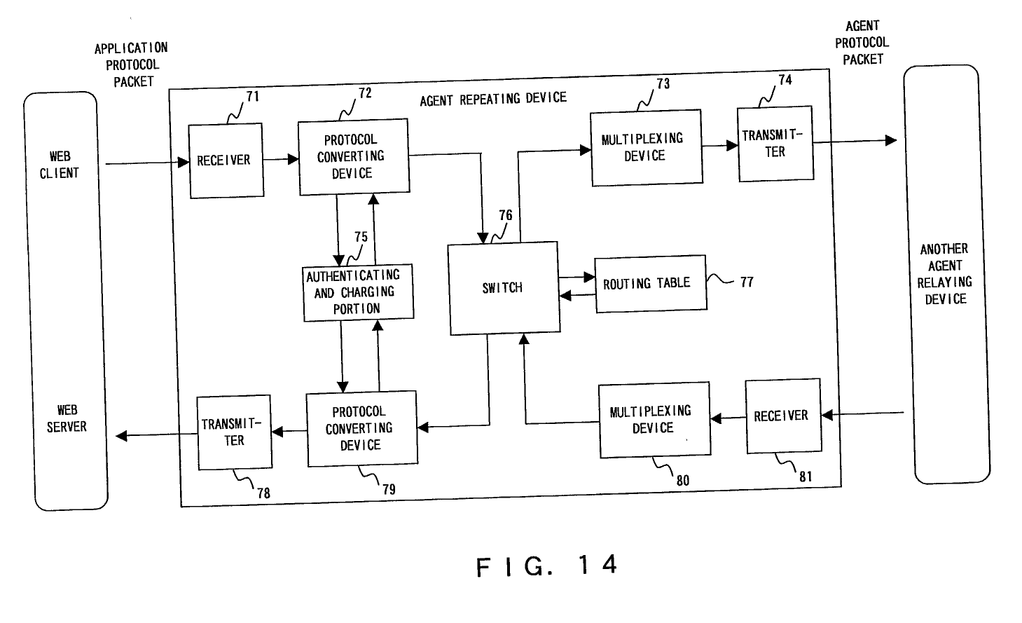

The agent relaying devices 13 and 14 may be structured with hardware instead of multiple program modules. FIG. 14 is a block diagram showing the structure of such an agent relaying device. The agent relaying device shown in FIG. 14 comprises receiving devices 71 and 81, protocol converting devices 72 and 79, multiplexing devices 73 and 80, transmitters 74 and 78, an authenticating and charging portion 75, a switch 76, and a routing table 77. The structural elements are disposed as hardware circuits. The structural elements perform the same operations as the modules shown in FIG. 7

Nowadays, on Web, to improve presentation effects, profile users, and customize Web pages, dynamic objects are becoming common instead of static objects. Thus, since the amount of data that is transferred increases, the effect of the reduction of traffic using cache servers remarkably deteriorates.

When mirror servers are simply distributed worldwide, user profiles cannot be centrally managed. Thus, on Web, the flow of data tends to increase in the direction of servers that are information circulation sources.

According to a communicating system of the present invention, a communication throughput between a server and a client can be improved without need to prepare a cache and a mirror server. Thus, it is expected that the system will become more effective corresponding to the above described trend of Web.

According to a communication system of the present invention, a bypass that has a substantially high communication rate is formed on an IP network of the Internet using a tunneling method. The bypass provides premium services to users. In addition, the bypass provides a unique means that attracts users to service providers.

According to the present invention, a throughput between a client and a server can be improved in long distance Internet communications having large delays such as intercontinental communications and satellite communications.

Although the present invention has been shown and described with respect to a best mode embodiment thereof, it should be understood by those skilled in the art that the foregoing and various other changes, omissions, and additions in the form and detail thereof may be made therein without departing from the spirit and scope of the present invention.

What is claimed is:

1. A communicating system for relaying a communication between a server and a client, comprising:
a buffer buffering data transmitted from the server to the client and accelerating data output from the server so as to increase a throughput assigned to a connection to the client by the server; and
a transferring device transferring data stored in said buffer to the client.

2. A communicating system for relaying a communication between a server and a client, comprising:
a receiving device receiving data transmitted from the server to the client;
a converting device converting a protocol of the received data into another protocol that allows a larger amount of data to be transferred at a time; and
a transmitting device transmitting data converted by said converting device to a network.

3. The communicating system as set forth in claim 2, further comprising:
a multiplexing device multiplexing data of multiple connections converted by said converting device,
wherein said transmitting device transmits the multiplexed data.

4. The communicating system as set forth in claim 2, further comprising:
an idling device performing an idling operation corresponding to a resource assigned to the client,
wherein said transmitting device transmits data after the idling operation is completed.

5. The communicating system as set forth in claim 2, further comprising:
a charging device performing a charging process for a service provider of the server,
wherein said receiving device receives a request from the client through the network,
wherein said charging device determines whether or not the request from the client is a request to be issued to the server,
wherein when the request from the client is the request to be issued to the server, said transmitting device transfers the request from the client to the server and said charging device charges the service provider.

6. A communicating system for relaying a communication between a server and a client, comprising:
a receiving device receiving data from a network, the data obtained by converting a protocol of data transmitted from the server to the client into another protocol that allows a larger amount of data to be transferred at a time;
a converting device converting the protocol of the received data into the original protocol; and
a transmitting device transmitting the data converted by said converting device to the client.

7. The communicating system as set forth in claim 6, further comprising:
a demultiplexing device demultiplexing data that has been multiplexed,
wherein said receiving device receives multiplexed data in which data of multiple connections has been multiplexed,
wherein said demultiplexing device demultiplexes the received data, and
wherein said converting device converts a protocol of the demultiplexed data.

8. The communicating system as set forth in claim 6, further comprising:
a charging device performing a charging process for a user of the client,
wherein said receiving device receives a request to the server from the network,
wherein said charging device determines whether or not the request to the server is a request from the client, and
wherein when the request to the server is the request from the client, said transmitting device transmits the request to the server and said charging device charges the user.

9. A computer-readable recording medium on which a program for a computer controlling a communication between a server and a client is recorded, said program causing the computer to perform:
buffering data transmitted from the server to the client and accelerating data output from the server so as to increase a throughput assigned to a connection to the client by the server; and
transferring the buffered data to the client.

10. A computer-readable recording medium on which a program for a computer controlling a communication between a server and a client is recorded, said program causing the computer to perform:
receiving data transmitted from the server to the client;
converting a protocol of the received data into another protocol that allows a larger amount of data to be transferred at a time; and
transmitting the converted data to a network.

11. A computer-readable recording medium on which a program for a computer controlling a communication between a server and a client is recorded, said program causing the computer to perform:
receiving data from a network, the data obtained by converting a protocol of data transmitted from the server to the client into another protocol that allows a larger amount of data to be transferred at a time;
converting the protocol of the received data into the original protocol; and
transmitting the converted data to the client.

12. A communicating method, comprising:
forming a virtual tunnel for hiding a network delay that takes place between a server and a client; and
using the virtual tunnel as a communication bypass between the server and the client so as to increase a throughput between the server and the client.

13. The communicating method as set forth in claim 12, further comprising:
charging a user of the client for a communication using the virtual tunnel.

14. The communicating method as set forth in claim 12, further comprising:
charging a service provider of the server for a communication using the virtual tunnel.

15. A communicating system for relaying a communication between a server and a client, comprising:
buffer means for buffering data transmitted from the server to the client and accelerating data output from the server so as to increase a throughput assigned to a connection to the client by the server; and
transferring means for transferring data stored in said buffer means to the client.

16. A communicating system for relaying a communication between a server and a client, comprising:
receiving means for receiving data transmitted from the server to the client;
converting means for converting a protocol of the received data into another protocol that allows a larger amount of data to be transferred at a time; and
transmitting means for transmitting data converted by said converting means to a network.

17. A communicating system for relaying a communication between a server and a client, comprising:
receiving means for receiving data from a network, the data obtained by converting a protocol of data transmitted from the server to the client into another protocol that allows a larger amount of data to be transferred at a time;
converting means for converting the protocol of the received data into the original protocol; and
transmitting means for transmitting the data converted by said converting means to the client.

18. A propagation signal for propagating a program to a computer controlling a communication between a server and a client, said program causing the computer to perform:
buffering data transmitted from the server to the client and accelerating data output from the server so as to increase a throughput assigned to a connection to the client by the server; and
transferring the buffered data to the client.

19. A propagation signal for propagating a program to a computer controlling a communication between a server and a client, said program causing the computer to perform:
receiving data transmitted from the server to the client;
converting a protocol of the received data into another protocol that allows a larger amount of data to be transferred at a time; and
transmitting the converted data to a network.

20. A propagation signal for propagating a program to a computer controlling a communication between a server and a client, said program causing the computer to perform:
receiving data from a network, the data obtained by converting a protocol of data transmitted from the server to the client into another protocol that allows a larger amount of data to be transferred at a time;
converting the protocol of the received data into the original protocol; and
transmitting the converted data to the client.
